(19) United States
(12) Patent Application Publication
(10) Pub. No.: US 2003/0122271 A1
(43) Pub. Date: Jul. 3, 2003

(54) Laminated paste for a dental crown and preparation method thereof

(76) Inventor: Dae-Hyun Kim, Seoul (KR)

Correspondence Address: Raj S Dave, Morrison & Foerster, 2000 Pennsylvania Avenue NW, Washington, DC, 20006-1888, US

(21) Appl. No.: 10/203,072

(22) PCT Filed: Dec. 18, 2001
(86) PCT No.: PCT/KR01/02195

(30) Foreign Application Priority Data
Dec. 18, 2000 (KR) 2000/77755

(51) Int. Cl. A61C 13/00; A61C 5/08

(52) U.S. Cl. 264/20; 106/35; 523/115

(57) ABSTRACT

Laminated paste for a dental crown and preparation method thereof are disclosed. Ceramic powders for dental crown added by aqueous additives are mixed with each other and are laminated as paste state in appropriate of the order of dental crown forming layers.

### TECHNICAL FIELD

The present invention relates to a laminated paste for a dental crown and a preparation method thereof, and particularly, to a paste made by laminating ceramic powders used in an artificial dental crown as a paste state.

### BACKGROUND ART

Generally, an artificial dental crown is used in order to restore a function of teeth which is damaged by an accident, disease or hurt or to improve an aesthetic of the teeth. The dental crown may be fabricated using precious metals such as gold, platinum, and palladium, using a form in which ceramic power is melted and fused to non-precious metals such as nickel and chrome, or using a form in which ceramic is built up on a ceramic core and then fired.

The ceramic power for dental use can be classified as high temperature, mid-temperature, and low temperature. The ceramic powders for mid-temperature and low temperature are made by adding a flux in the material for high temperature. A method for fabricating the dental ceramic powder to be a predetermined shape so as to be similar with a tooth will be described as follows. The material including the flux is melted in the temperature of 1200˜1500° C. to be frit, and then, cooled rapidly in water, and pulverized. The powdered ceramic is mixed in the water (distilled water) or in the water-soluble solution to be the paste state having viscosity, and the paste is made to be corresponding to the teeth shape of a patient by a manual build-up process of a dental technician. The color of ceramic powder is selected by the shade selection process by the dental technician based on a reference shade guide. This process is largely depended on the experience and observation of the shade and color of natural teeth by a dental technician.

FIG. 1a is a cross sectional view showing a structure of a tooth. As shown therein, the tooth comprises a crown and a root, the crown is a part above the gum, and the root is a part buried in an alveolar bone. In the Figure, the tooth comprises an enamel 1 which is an exterior part of the tooth and the hardest part; a dentine 2 which is a principal part making a form of the tooth under the enamel 1; a cementum 4 performing a function as being attached to the jawbone (alveolar bone) surrounding the dentine of root unit under the gum; a pulp 3 which is located in the tooth and provides the tooth with nutrition which including blood vessel, nerve fiber, and lymph vessel; a periodontal ligament 5 connecting the root cementum and the bone; an alveolar bone 6 for supporting the tooth located under the periodontium 5; and a gum 7 which is a pink mucosa for protecting the alveolar bone around the tooth.

The artificial dental crown should be fabricated as close as possible according to the state of the each patient by selecting materials satisfying the conditions such as shape, color, intensity, and durability of the enamel 1 and the dentine 2 which are the crown unit. FIG. 1b is a cross sectional view showing a general ceramic crown. As shown therein, the ceramic crown comprises a metal coping (or ceramic core) 10 which is covered on the tooth; an opaque material 20 for compensating the color of the metal crown; a dentine material 25 corresponding to the dentine of the tooth; and an enamel material 30 and a transparent material 35 corresponding the exterior part of the tooth. FIG. 1c is a cross sectional view showing the ceramic crown, and as shown therein, the ceramic crown is formed to be very similar with the real tooth. The shade of the artificial crown is determined by the dentine 25 and the enamel material 30.

The method for fabricating the ceramic crown will be described in order with reference to FIGS. 2a through 2k as follows. Respective ceramic is made to be the powdered state, and then, mixed in the distilled water or in the water-soluble solution to be the paste state. The color of the metal coping or the ceramic core crown needs to be revised. In case of the metal coping, the surface of the metal is treated with abrasives in order to facilitate the attachment with the ceramic powder easy (FIG. 2a), and then opaque material is applied thereon for the first time (FIG. 2b). The applied opaque material is fired (FIG. 2c), and after that, the opaque material having similar color tone with that of the tooth is applied secondly (FIG. 2d) and fired(FIG. 2e). In addition, the dentine material which is a principal element for the color tone of the tooth is built up on the opaque material (FIG. 2f). The build-up of the dentine material is repeated a plurality of times as laminating layers on the opaque material, and the basic form of the tooth is made by maintaining the thickness constantly. Then, the enamel material is built up on the end part of the tooth in order to reproduce the enamel part of the tooth (FIG. 2g), and the transparent material is built up for the transparency of the entire tooth (FIG. 2h). When the built-up-process is completed, the artificial dental crown is fired for the first time. FIG. 2i shows the fired artificial crown. The shape of the artificial crown is corrected to be the shape of the tooth after the first firing process (FIG. 2j). When the correction is completed, a second firing process is performed. In addition, FIG. 2k shows the completed artificial dental crown.

The fabrication method for the artificial dental crown is performed by a plurality of manual working processes, and therefore, it takes much time and effort. Especially, it takes about 30˜60 minutes to built up the opaque material, the dentine material, and the enamel material, and it may take more time according to the characteristic of the process. Also, the built-up process may be differentiated according to the capacity and the experience of the dental technician, and different results are caused by external variables such as differences in the color and strength according to the added amount of the water or solution in which the ceramic powder is mixed, and evaporation of the water or the solution. In the above reasons, it is uncertain to obtain natural and aesthetic tooth color and physical strength. Therefore, an experienced technician is able to fabricate the high quality artificial dental crown under the best working condition. However, it is difficult to reproduce the color tone of the tooth due to the uncertain communication between the observer who observes the color tone of the natural tooth and the producer who fabricates the artificial crown be being transmitted the color tone information from the observer. Therefore, there are many problems in fabricating the artificial dental crown.

### SUMMARY OF THE PRESENT INVENTION

Therefore, an object of the present invention is to provide means which are able to overcome difficulties in fabricating an artificial dental crown by a manual working. Also, another object of the present invention is to provide a suitability and continuity of reproducing a color of tooth and provide a simplicity in ceramic build-up by selecting and using various ceramic products corresponding to the color tone of the tooth.

To achieve the above objects of the present invention, this invention provided a laminated paste that is made by several pastes maintaining the viscosity by mixing dental ceramic powder and liquid additive in order of respective parts constituting the dental crown.

The laminated paste fabricated in advance using the liquid additive can be formed similar with the tooth, and can be changed according to the respective patient situation. According to the conventional built-up process of the artificial dental crown, it takes a lot of times to fabricate the dental crown by the manual working and many variables are generated by the manual work of the technician. However, according to the present invention, various prefabricated ceramic pastes can be provided, and thereby, the fabricating time can be reduced and the characteristics of the artificial dental crown changed by the mechanic can be standardized.

### BRIEF DESCRIPTION OF THE DRAWINGS

FIG. 1a is a cross sectional view showing a structure of a tooth;

FIG. 1b is a cross sectional view showing a structure of a ceramic dental crown;

FIG. 1c is a front view showing the ceramic dental crown; and

FIGS. 2a through 2k are photographs showing respective fabricating process of the ceramic dental crown according to the conventional manual working.

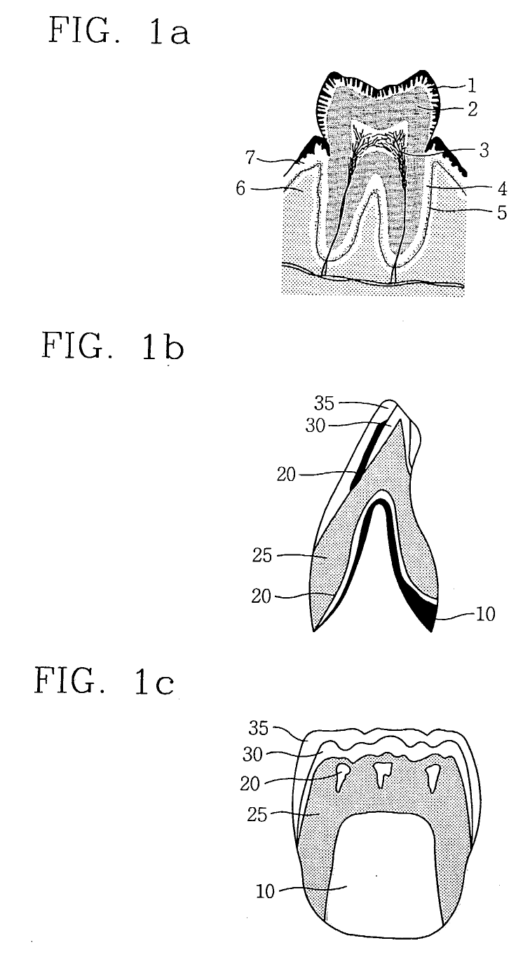

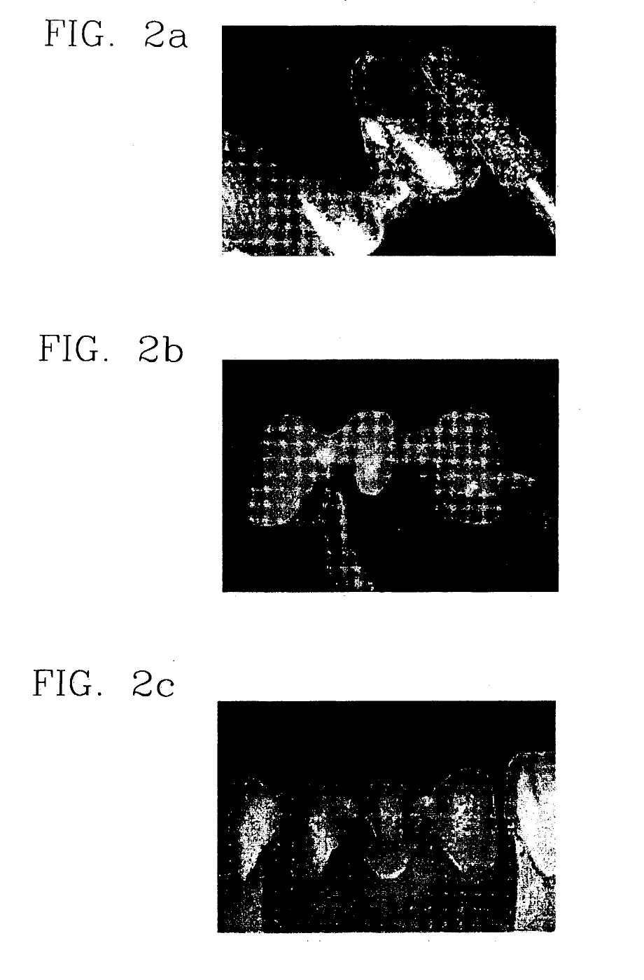

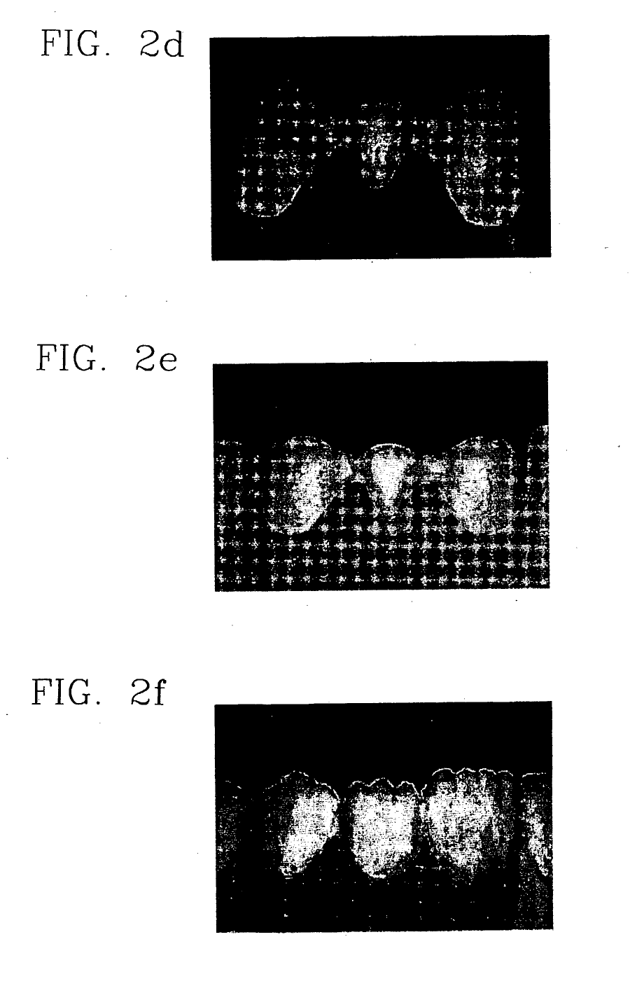

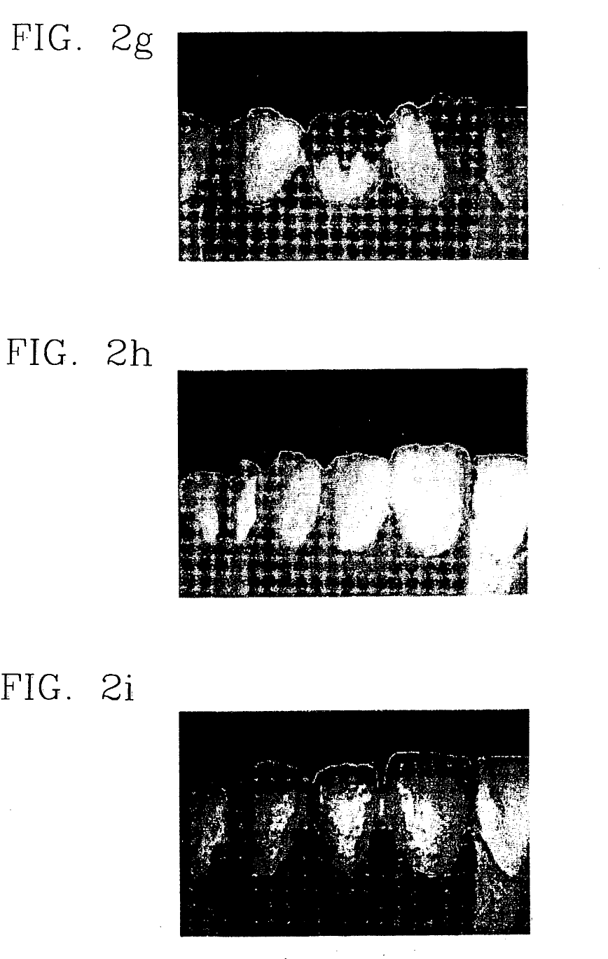

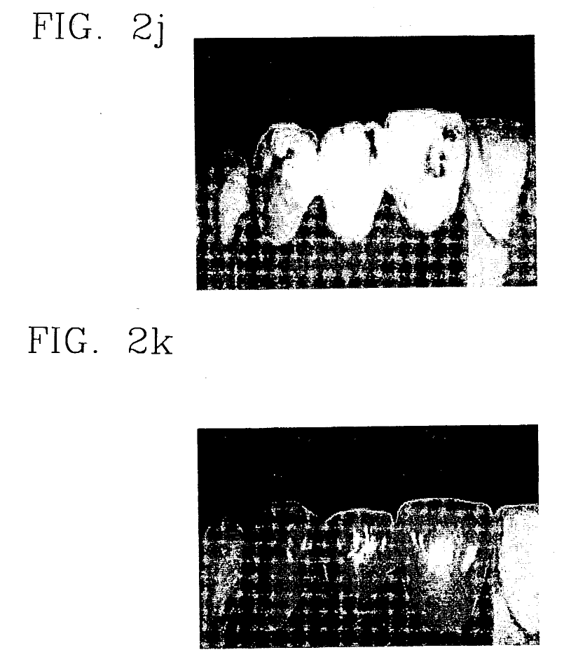

### MODE FOR CARRYING OUT THE PREFERRED EMBODIMENTS

According to the present invention, a liquid additive is mixed in an opacity material, a dentine material, an enamel material, and a transparent material appropriately to control the viscosity and flowing of the ceramic, respective powders are made to be paste, and then laminated in a mold to make a laminated paste.

The liquid additive is usually a water-soluble liquid additive. The additive functions as a binding agent for generating the adhesive strength in the powder and for improving the cohesion by giving a cross-link, and also functions as a plasticizer for providing the paste with flexibility and plasticity. Polyether polyol, polyhydric alcohol, formaldehyde, allkanolamine, polyvinylether, nonionic surfactant, or a mixture of them are used as the liquid additive. Desirably, glycol in the polyhydric alcohol is used as the liquid additive, and propylene glycol, and ethylene glycol maintains the viscosity of the ceramic powder constantly and combusted at relatively lower temperature, and therefore, these are suitable for the liquid additive. Also, a solution in which glycerin and distilled water of same amounts are mixed and heated in boiling water can be used the liquid additive in the present invention. Also, the water can be used as an additional solvent, and besides, the solvent such as the alcohol can be used.

Besides, the materials of liquid state, by which the paste can be built up on a surface of an alloy or on a ceramic core, the attachment with the alloy or the ceramic core can be maintained after built up on the alloy or the ceramic core, the paste status can be maintained for a long time because the liquid additive is not evaporated, and the product of combustion is not remained after debinding process by the heat processing, can be used as the liquid additives.

The liquid additives as above are well mixed with the ceramic powder. In addition, these make the ceramic powder to be fine and move the ceramic particles between the other particles during condensing the paste after forming the paste to the tooth shape. Also, it can be easy to handle the paste, the fabrication of the dental crown can be made rapidly and accurately, and thereby the quality of the dental crown can be improved.

On the other hand, the adding rate of the ceramic powder is also an important element in the mixture of paste state. The adding rate should be shown as high as possible within the range the flexibility and the coherence can be shown. The adding rate depends on the particle distribution of the ceramic powder and the average diameter. It is desirable that the average diameter of the ceramic powder is between 10˜15 μm.

The laminated paste according to the present invention can be variable in the viscosity in accordance with the added amount of the liquid additive. In addition, the viscosity is controlled according to the object or purpose of usage. Therefore, the paste in the present invention can be variable from a watery state as the toothpaste to the hard state as a rice cake or a caramel.

In the present invention, the powder used in the conventional method is divided according to the color or function. The dental ceramic is a kind of porcelain, the porcelain includes 40˜60% of kaolin, 25˜40% of quartz, and 20˜30% of feldspar, however, the dental ceramic includes 80˜95% of feldspar. Also, about 10% of quartz is added in order to increase the strength of the dental crown. The fusion point of the feldspar is about 1250˜1500° C., and the fusion point of the quartz is about 1800° C. The fusion point of the feldspar is lower than that of the quartz, and therefore, the dental ceramic is finally the glass in which the quartz is the core, and the feldspar is the substrate. On the other hand, a small amount of kaolin (natural aluminium silicate, and china clay) may be added in order to improve the plasticity.

The dental ceramic requires high transparency in order to reproduce the color of the tooth. When the added amount of the quartz or the kaolin is increased, the transparency is lowered. On the contrary, as the added amount of the quartz is increased, the strength of the artificial tooth is increased. In case of the dental ceramic, the feldspar is added in order to improve the transparency even though the durability is lowered more or less. Therefore, it is suitable that the dental ceramic is called as feldspar glass. The feldspar has relatively lower fusion point, and has high transparency after the fusion process because it becomes the glass state of high viscosity. Among various feldspars such as potash feldspar, soda feldspar, anorthite, and calsian, the potash feldspar is mainly used as the dental material because it has high viscosity, and has fine polish and transparency after firing. The potash feldspar includes 65.7% of SiO₂, 18.4% of Al₂O₃, and 16.9% of K₂O, and expressed as following chemical formula K₂O Al₂O₃. 6 SiO₂. However, more or less impurities are mixed in the natural feldspar. Therefore, the potash feldspar having less impurities as possible is used as the dental ceramic in the present invention. Also, the ceramic of fine-particle, or the fluorapatite glass-ceramic which is the feldspar-free glass ceramic can be used.

An embodiment of the method for fabricating the laminated paste will be described as follows. The liquid additive 0.04 g is mixed with the dentine ceramic powder 0.15 g, and the mixture is put into a mold as the paste state to form a predetermined shape. In addition, the ceramic powder 0.05 g used as the enamel material and the liquid additive 0.01 g are mixed, put into the mold as the paste state, and then laminated. Next, the ceramic powder used as the transparent material 0.13 g and the liquid additive 0.02 g are mixed, put into the mold as the paste state, and then laminated. Therefore, the laminated single paste of viscose status is made.

The added amount of the ceramic powder is changed according to the color or transparency of the tooth of the patient when the paste is fabricated. The kind or the order of the laminated ceramic powder can be changed. Also, the number of the laminated paste can be changed according to the number of the dental crown. Also, it is desirable that a reference table according to the color or the transparency is made to standardize the paste, and the standardized goods are selected according to the status of the tooth.

The completed laminated paste is packed in order to maintain the viscose state. A product corresponding the reference table is selected according to the status of the tooth, and the package should be opened when it is about to be used.

In actual practice, the watery mixed porcelain can be applied on a opaque treated metal core or on a all ceramic core before the application with laminated paste of the present invention. On the applied watery ceramic, the laminated paste of the present invention is attached, then, the paste is formed to be the tooth shape as lightly vibrating. After the plasticized paste is dried for a certain period, and then, fired to complete final artificial dental crown. After firing, a general ceramic may be added and fired again at need.

### INDUSTRIAL APPLICABILITY

As so far described, according to the present invention, the difficulties of the ceramic built-up caused by overtime generated in the manual work and incapability of the operator, the changes in bio rhythm of the operator during fabricating or in added amount of the water or solution used when the ceramic is built up, or the environmental elements such as the evaporation of water or the solution can be solved. Therefore, the less experienced dental technician is able to fabricate the dental crown in a short time, and the final ceramic dental crown can be standardized to be a predetermined shape. Also aesthetic results can be achieved by improving communication between the observer and the technician and therefore, the quality of the dental crown can be improved.

1. A laminated paste for dental crown which is made by laminating paste maintaining viscosity by mixing a liquid additive in a dental ceramic powder used for an artificial dental crown in order of respective components constituting the dental crown.

2. The paste of claim 1, wherein the dental crown comprises an opacity material, a dentine material, an enamel material, and a transparent material.

3. The paste of claim 1, wherein the liquid additive is one of polyether polyol, polyhydric alcohol, formaldehyde, allkanolamine, polyvinylether, nonionic surfactant, or a mixture of them.

4. The paste of claim 3, wherein water or alcohol is added in the liquid additive as an additional solvent.

5. The paste of claim 3, wherein the polyhydric alcohol is one of propylene glycol or ethylene glycol.

6. The paste of claim 1, wherein the liquid additive is a solution in which glycerin and water of same amounts are put into a chamber and heated in a boiling water.

7. A method for fabricating a laminated paste for dental crown comprising:
a step of fabricating paste of viscose state by mixing liquid additive in respective dental ceramic powder constituting an artificial dental crown and pasting; and
a step of laminating the respective pastes to be a predetermined shape by putting into a mold according to a color tone and a transparency of a tooth in order of forming.

8. The method of claim 7 further comprising a step of packing the laminated paste.
